(19) United States
(12) Patent Application Publication
(10) Pub. No.: US 2016/0078211 A1
(43) Pub. Date: Mar. 17, 2016

(54) LOCATION SIGNATURES

(71) Applicant: HEWLETT-PACKARD DEVELOPMENT COMPANY, L.P., Houston, TX (US)

(72) Inventors: Christopher Newton, Bristol (GB); Patrick Goldsack, Bristol (GB); Chris I Dalton, Bristol (GB)

(21) Appl. No.: 14/785,433

(22) PCT Filed: Apr. 24, 2013
(86) PCT No.: PCT/US2013/038017

§ 371 Date: Oct. 19, 2015

(51) Int. Cl. G06F 21/34

(52) U.S. Cl. CPC G06F 21/34

(57) ABSTRACT

In one implementation, a security management system accesses a trusted location signature and a candidate location signature to determine that the candidate location signature is correlated with the trusted location signature, and establishes a trusted state of an entity in response to determining that the candidate location signature is correlated with the trusted location signature.

### BACKGROUND

In many systems, establishment of a trusted state of an entity depends on a credential or secret held by that entity. For example, an entity can log into a network-based service or resource by providing a credential such as a password to that service to establish a trusted state of that entity within that service. The entity can typically perform privileged operations after logging into that service until the trusted state is revoked. The trusted state can be revoked when the entity is logged out of the service at its request or in response to some condition such as a forbidden or invalid operation (or request for an operation).

Similarly, in some systems, the trusted state of an entity depends on a credential demonstrated by a relationship of that entity with another system. For example, a trusted state of an entity can be established within a network-based service or resource so long as the entity communicates with that service via a communications link established between that service and another system (e.g., an enterprise intra-network). As another example, a trusted state of an entity can be established within a network-based service or resource so long as another system verifies to that service that the entity has a trusted state within the other system.

### BRIEF DESCRIPTION OF THE DRAWINGS

FIG. 1 is a flowchart of a security management process, according to an implementation.

FIGS. 2A, 2B and 2C illustrate an environment including a security management system, according to an implementation.

FIGS. 3A, 3B and 3C illustrate an environment including a security management system, according to another implementation.

FIGS. 4A, 4B and 4C illustrate an environment including a security management system, according to another implementation.

FIG. 5 is a schematic block diagram of a computing system hosting a security management system, according to an implementation.

### DETAILED DESCRIPTION

A trusted state of an entity is typically established for or within a service (or resource) after the entity demonstrates that it has access to some credential or group of credentials. As discussed above, such a credential can be a secret such as a password, a token, or a relationship (e.g., a trusted or secure communications session) with another system. As other example, a credential can be a secret such as a private key or a public/private encryption key pair, a symmetric encryption key, or some other secret or private data.

Alternatively, a trusted state of an entity can be established for a service if the entity or some device associated with the entity is located in a particular geographic location. For example, using a positioning system such as the Global Positioning System (GPS) a device can determine its location, and provide that location to the service. If the location is within a region approved or authorized by the service, a trusted state of the entity for the service can be established.

In some applications, a trusted state of an entity is established and maintained (e.g., not revoked) while a device associated with that entity is at or near a particular location. Some such applications require that a trusted state of an entity should only be established and maintained while a device associated with that entity is at or near a particular location where traditional positioning systems are not available (e.g., where GPS satellites or other beacons cannot be received or sensed).

Implementations discussed herein determine whether an entity associated with a device should be trusted based on location signatures generated at that device and at a trusted device. As an example, a device generates a candidate location signature based on environment signals sensed or detected at the device. A trusted device generates a trusted location signature based on environment signals sensed or detected at the trusted device. The device and the trusted device provide the candidate location signature and the trusted location signature, respectively, to a security management system, which determines whether the candidate location signature and the trusted location signature are correlated. If the candidate location signature and the trusted location signature are correlated, the security management system determines that the entity should be trusted and establishes a trusted state of the entity.

Moreover, in some implementations discussed herein, the device and trusted device continually or periodically provide candidate location signatures and trusted location signatures, respectively, to the security management system. The security management system determines whether each candidate location signature is correlated with a corresponding trusted location signature. If that candidate location signature is correlated with the corresponding trusted location signature, the trusted state of the entity is maintained (e.g., unchanged). If, however, that candidate location signature is not correlated with the corresponding trusted location signature, the trusted state of the entity is revoked. Similarly, if a candidate location signature is received for which no corresponding trusted location signature is received or if a trusted location signature is received for which no corresponding candidate location signature is received, the trusted state of the entity can be revoked.

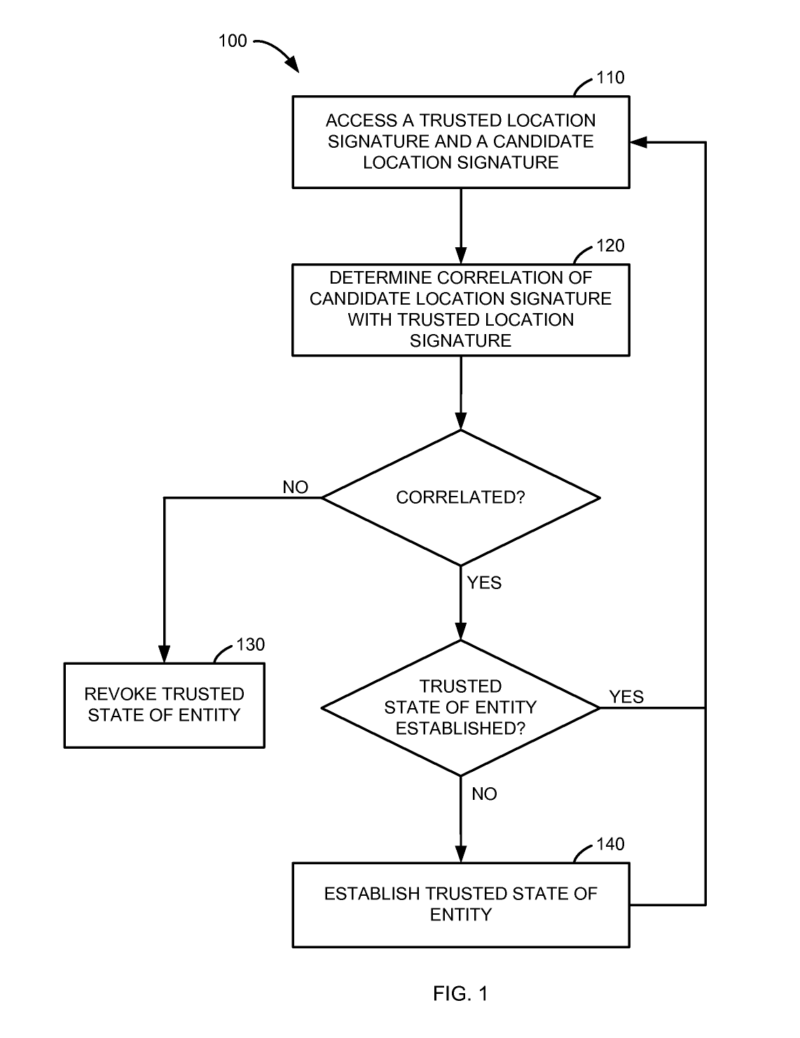

FIG. 1 is a flowchart of a security management process, according to an implementation. Process 100 can be implemented, for example, at a security management system hosted at a computing system. A trusted location signature and a candidate location signature are accessed at block 110. A location signature is a representation of environment signals of a location. For example, environment signals such as vibration signals, electromagnetic signals, sonic (e.g., audible, ultrasonic, or sub-sonic) signals, illumination signals (e.g., illumination levels or light flicker), or other signals. Such environment signals can be noise (e.g., ambient to the location) or can be purposefully generated. Such environment signals can be sensed or detect at location signature modules, which define location signature based on such environment signals.

A trusted location signature is a location signature that is trusted or assumed to be an accurate or valid representation of environment signals (or signal) of a location. Typically, trusted location signatures are defined at and/or provided by trusted devices. A candidate location signature is a location signature that is to be tested against or compared with a trusted location signature to determine whether the candidate location signature is correlated with that trusted location signature. In some implementations, a device at which a candidate location signature was defined or generated is determined to be co-located with the location having the environment signals represented by a trusted location signature if that candidate location signature is correlated with that trusted location signature.

The trusted location signature and the candidate location signature accessed at block 110 can be accessed, for example, at a memory of a computing system. In some implementations, the trusted location signature is received from a trusted device and the candidate location signature is received from a device (i.e., a device other than a trusted device). The trusted location signature and the candidate location signature can be stored at a memory of a computing system after they are received from the trusted device and the device, respectively.

In some implementations, signals such as environment signals can be stable or periodic over time, and a trusted location signature can be defined based on those environment signals and stored within a memory of a computing system. Thus, for example, a trusted location signature for each of a group of locations can be stored within a database. At a later time (or later times), candidate location signatures can be received and compared with the trusted location signatures at the database to determine whether the candidate location signature is correlated with a trusted location signature from the trusted location signatures at the database. As discussed in more detail herein, if a candidate location signature is correlated with a trusted location signature, a trust state associated with or related to the location can be established for an entity.

In some implementations, the security management system implementing process 100 is hosted at the device. In such implementations, the trusted location signature is received from a trusted device and the candidate location signature is accessed at a location signature module at the device. In yet other implementations, the security management system implementing process 100 is hosted at the trusted device. In such implementations, the candidate location signature is received from a device and the trusted location signature is accessed at a location signature module at the trusted device.

The candidate location signature is then compared with the trusted location signature at block 120 to determine whether the candidate location signature is correlated with the trusted location signature. A candidate location signature can be said to be correlated with a trusted location signature if the candidate location signature meets or exceeds a similarity threshold with the trusted location signature. In other words, the candidate location signature can be said to be correlated with a trusted location signature if the candidate location signature satisfies a similarity threshold with (or is sufficiently similar to) the trusted location signature. For example, the candidate location signature can be said to be correlated with a trusted location signature if a predetermined percentage of the candidate location signature is the same as a portion or portions of the trusted location signature. As a specific example, the candidate location signature can be said to be correlated with a trusted location signature if the candidate location signature (or relevant portion thereof) is 95% or more similar with the trusted location signature (or relevant portion thereof).

In some implementations, a candidate location signature and/or a trusted location signature is scaled, stretched, temporally shifted or otherwise modified at block 120 to facilitate comparison of the candidate location signature and the trusted location signature. In other words, the candidate location signature and trusted location signature can be compared using a variety of methodologies to determine whether the candidate location signature is correlated with the trusted location signature.

For example, the candidate location signature and the trusted location signature can each represent environment signals sensed or detected during a period of 100 ms. At block 120, the amplitudes of the candidate location signature and the trusted location signature can be normalized, and the candidate location signature can be shifted relative to the trusted location signature to identify a 50-ms portion of the candidate location signature (i.e., one half portion of the candidate location signature) that is most similar to a 50-ms portion of the trusted location signature (i.e., one half portion of the trusted location signature). Each 50-ms portion can then be compared to determine whether the candidate location signature satisfies a similarity threshold with (i.e., is correlated with) the trusted location signature.

If the candidate location signature is correlated with the trusted location signature, and a trusted state of an entity has not yet been established, process 100 proceeds to block 140 at which a trusted state of the entity is established. An entity can be, for example, a client of a service or resource, a software application such as a user agent, a user account, or a context of a web application that can be in a trusted state (or any of a variety of trusted states) or an untrusted state. A trusted state is a state in which an entity is authorized to perform operations such as privileged operations that are not allowed when the entity is not in the trusted state. For example, such privileged operations can include accessing (e.g., reading, writing, or modifying) data such as confidential or restricted information, communicating via a communications link, communicating or associating with other entities, accessing an intranet or internal network of an enterprise, executing commands or applications, and/or other privileged operations. In some implementations, a trusted state of an entity is established by providing a credential such as a password or digital certificate to the entity.

The entity can be, for example, an entity associated with a device from which the candidate location signature is received. For example, the entity can be hosted at that device. As another example, the entity can be hosted at a computing system separate from that device, and the entity (or computing system hosting the entity) and that device can provide a unique identifier, a session identifier, or a token associated with the entity to the security management system to indicate a relationship between that device and the entity. The displacement signature service can then use the unique identifier, the session identifier, and/or the token to establish the trusted state of the entity.

The security management system implementing process 100 can establish the trusted state of the entity using a variety of methodologies. For example, the security management system can modify one or more state variables of the entity, provide a credential to the entity, or by otherwise indicating that the entity is in a trusted state. As another example, the security management system can provide a token to the entity (directly or via the device at which the candidate location signature was defined) or can alter a privilege or permission state of the entity to establish the trusted state of the entity.

Referring again to block 120, if the candidate location signature is correlated with the trusted location signature and a trusted state of an entity has already been established, process 100 proceeds to block 11 at which another candidate location signature and another trusted location signature are received. Accordingly, the trusted state of the entity is maintained. If, however, the candidate location signature is not correlated with the trusted location signature, process 100 proceeds to block 130 at which a trusted state of the entity is revoked. Alternatively, if the trusted state of the entity has not yet been established, process 100 can terminate at block 130 or can return to block 110 to access another candidate location signature and another trusted location signature.

The trusted state of the entity can be revoked according to a variety of methodologies. For example, a credential or token can be deleted or invalidated to revoke the trusted state of the entity. As another example, a security management system can revoke the trusted state of the entity by providing a revocation notification to the entity or can modify a state variable of the entity to cause the trusted state of the entity to be revoked. In some implementations, the security management system notify a resource or a security validation service with which a trust state, credential, or token is validated by resources and/or services that the trust state should be revoked. As a result of the revocation of the trusted state of the entity, the entity can be, for example, unable to perform privileged operations.

Process 100 illustrated in FIG. 1 is an example security management process. Other security management processes can include different and/or additional blocks or steps. For example, in some implementations, a security management process includes temporally coordinating definition of candidate location signatures and trusted location signatures. As a specific example, a computing system hosting the security management process can provide synchronization signals to a device and a trusted device to cause the device and the trusted device to define candidate location signatures and trusted location signatures, respectively, at approximately the same time. Because the environment signals represented in location signatures typically vary temporally, such implementations can be useful to definition of candidate location signatures and trusted location signatures that are correlated.

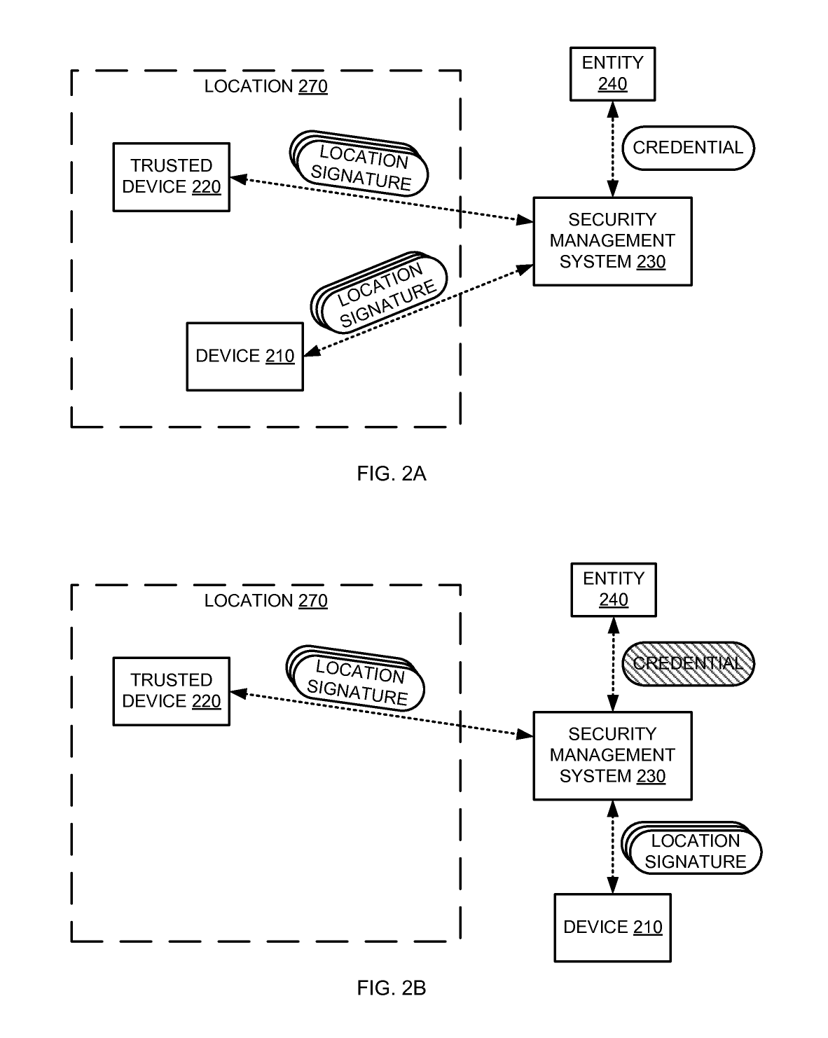

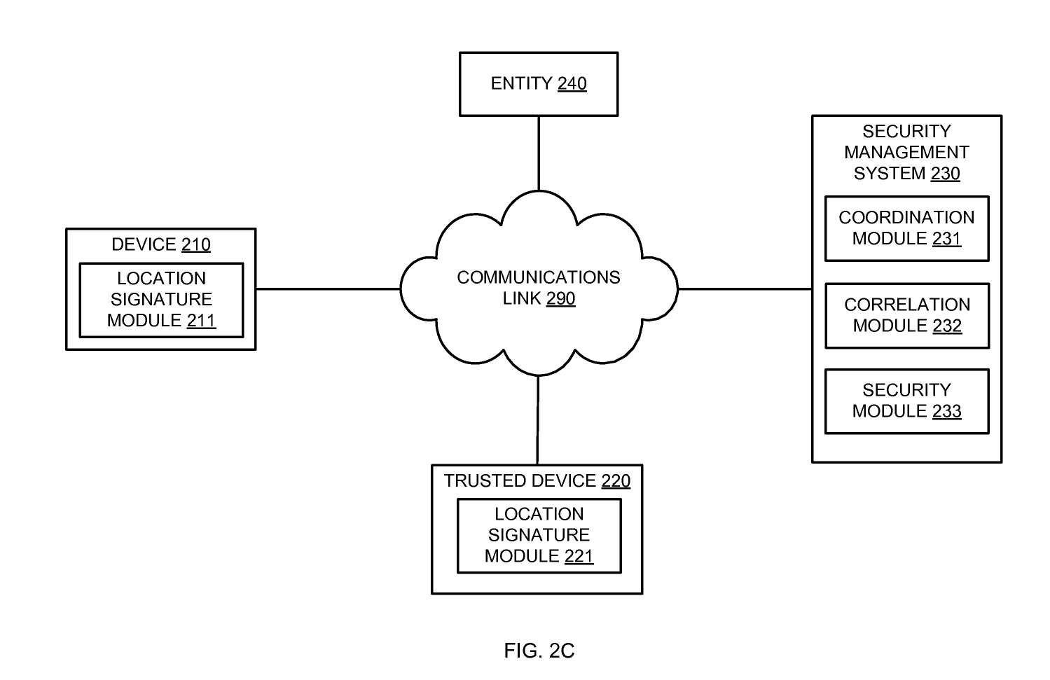

FIGS. 2A, 2B and 2C illustrate an environment including a security management system, according to an implementation. The environment illustrated in FIGS. 2A and 2B includes location 270, device 210, trusted device 220, and security management 230. Location 270 can be any location such as a conference room within a building. Device 210 is a device such as a laptop computer, a smartphone, a tablet device, other computing system that includes a location signature module to define candidate location signatures. Trusted device 220 is a device such as a laptop computer, a smartphone, a tablet device, other computing system that includes a location signature module to define trusted location signatures. Additionally, trusted device 220 has a trusted relationship with security management system 230. That is, security management system 230 interprets location signatures received from trusted device 220 as trusted or valid, and as describing a location that is secure (or trusted). Location signatures received from trusted device 220 are referred to as trusted location signatures. Accordingly, if candidate location signatures received from device 210 are correlated with trusted location signatures received from trusted device 220, security management system 230 determines that entity 240, which is associated with device 210, should be trusted and establishes a trusted state of entity 240.

As illustrated in FIG. 2A, device 210 and trusted device 220 are both located within (or at) location 270. Because device 210 and trusted device 220 are both located within location 270, the location signature modules at each of device 210 and trusted device 220 sense or detect similar environment signals. As a specific example, the location signature modules of device 210 and trusted device 220 include accelerometers that detect or sense vibrations within location 270. The vibrations can result from seismic activity, HVAC systems, movement within or near location 270, wind, or other phenomena. Such vibrations (or environment signals) can vary with time and location. Thus, the vibrations can be different at different times and within location 270 and outside location 270.

Security management system 230 can provide synchronization signals to device 210 and trusted device 220 to cause device 210 and trusted device 220 (or the location signature modules therein) to define location signatures at substantially the same time. For example, in response to a synchronization signal, device 210 and trusted device 220 each sample accelerometers to define location signatures. Thus, in this example, the location signatures include vibration data (i.e., data or values generated at an accelerometer such as values representing vibration signals sensed or detected at an accelerometer).

Device 210 and trusted device 220 then provide these location signatures to security management system 230, which determines whether the candidate location signature received from device 210 is correlated with the trusted location signature received from device 220. If the candidate location signature received from device 210 is correlated with the trusted location signature received from device 220, security management system 230 establishes a trusted state of entity 240. For example, as illustrated in FIG. 2A, security management system 230 can provide a credential to entity 240 to establish a security state of entity 240.

Device 210 and trusted device 220 then continue to provide location signatures to security management system 230. For example, device 210 and trusted device 220 can provide location signatures to security management system 230 continually or periodically. Moreover, security management system 230 can also continue to temporally coordinate definition of location signatures at device 210 and trusted device 220. For example, security management system 230 can provide synchronization signals to device 210 and trusted device 220 to cause device 210 and trusted device 220 to define location signature at substantially the same time.

As illustrated in FIG. 2B, at a later time, device 210 can have moved (or been moved) outside location 270. Because the environment signals on which the location signatures are based vary with location, the candidate location signatures provided to security management system 230 by device 210 when device 210 is outside location 270 are not correlated with the trusted location signatures provided to security management system 230 by trusted device 220 within location 270. As a result, security management system 230 revokes the trusted state of entity 240. In other words, security management system 230 determines that device 210 is no longer co-located with trusted device 220, and revokes the trusted state of entity 240 as a result. As illustrated in FIG. 2B, the credential provided to entity 240 can be revoked (e.g., invalidated) to revoke the trusted state of entity 240.

FIG. 2C illustrates connections among device 210, trusted device 220, security management system 230, and entity 240. As illustrated in FIG. 2C, device 210, trusted device 220, security management system 230, and entity 240 are in communication with another or others of device 210, trusted device 220, security management system 230, and entity 240 via communications link 290.

Communications link 290 includes devices, services, or combinations thereof that define communications paths between device 210, trusted device 220, security management system 230, entity 240, and/or other devices or services. For example, communications link 290 can include one or more of a cable (e.g., twisted-pair cable, coaxial cable, or fiber optic cable), a wireless link (e.g., radio-frequency link, indicative link, optical link, or sonic link), or any other connectors or systems that transmit or support transmission of signals. Moreover, communications link 290 can include communications networks such as a switch fabric, an intranet, the Internet, telecommunications networks, or a combination thereof. Additionally, communications link 290 can include proxies, routers, switches, gateways, bridges, load balancers, and similar communications devices. Furthermore, the connections or communications paths illustrated in FIG. 2C and discussed herein can be logical or physical.

Additionally, as illustrated in FIG. 2C, device 210 includes location signature module 211, trusted device 220 includes location signature 221, and security management system 230 includes coordination module 321, correlation module 232, and security module 233. Although particular modules (i.e., combinations of hardware and software) such as engines are illustrated and discussed in relation to FIG. 2C and other example implementations, other combinations or sub-combinations of modules can be included within other implementations. Said differently, although modules illustrated in FIG. 2C and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules.

A location signature module is a combination of hardware and software that defines the location signatures based on environment signals. For example, a location signature module can include an accelerometer to detect vibration signals such as seismic activity or artificially generated vibration signals, a microphone to detect sonic signals, a radio-frequency receiver to detect electromagnetic signals, a photodetector to detect illumination information, and/or some other mechanism or combination thereof to detect environment signals. The location signature can be a group, set, collection, or string of values that represent the environment signals. For example, a location signature can be a set of values sampled periodically at the output of an accelerometer or other mechanism that detects one or more environment signals.

In some implementations, a location signature module is in communication with a coordination module of a security management system to define location signatures in response to synchronization signals from the coordination module. Thus, location signatures defined at different location signature modules can be temporally coordinated to allow comparison of and correlation with one another. As a specific example, a location signature module at a device can be synchronized with a location signature module at a trusted device such that at least a portion of a candidate location signature (defined at the location signature module at the device) is defined at the same time at least a portion of a trusted location signature (defined at the location signature module at the trusted device) is defined. In other words, at least a portion of the candidate location signature represents the same environment signals represented by at least a portion of the trusted location signature.

A coordination module is a combination of hardware and software that temporally coordinates definition of location signatures at different devices. For example, a correlation module can temporally coordinate definition of candidate location signatures at a device and trusted location signatures at trusted devices. In some implementations, a coordination module communicates with location signature modules via a communications link to provide synchronization signals to the location signature modules. The location signature modules can define location signatures in response to the synchronization signals such that the location signatures are defined at substantially the same time.

A correlation module is a combination of hardware and software that determines whether location signatures are correlated. As a specific example, a correlation module receives a candidate location signature from a device and a trusted location signature from a trusted device and determines whether the candidate location signature is correlated with the trusted location signature. As discussed above, a correlation module can utilize a variety of methodologies to determine whether a candidate location signature is correlated with a trusted location signature. For example, a correlation module can normalize amplitudes of location signatures, temporally shift location signatures, filter, and/or otherwise process location signatures. Additionally, a correlation module can compare location signatures (e.g., values within location signatures) to determine whether one location signature satisfies a similarity threshold with another location signature.

A security module is a combination of hardware and software that establishes a trusted state of an entity if a first candidate location signature is correlated with a trusted location signature. Additionally, a security module revokes the trusted state of the entity if a candidate location signature is not correlated with a trusted location signature. For example, as discussed above, a security module can issue or provide (e.g., via a communications link) credentials and/or tokens to an entity, alter state variables of an entity, and/or modify permissions or privileges associated with an entity to establish a trusted state of an entity. Moreover, as examples, a security module can revoke or invalidate credentials and/or tokens to an entity, alter state variables of an entity, and/or modify permissions or privileges associated with an entity to revoke a trusted state of an entity.

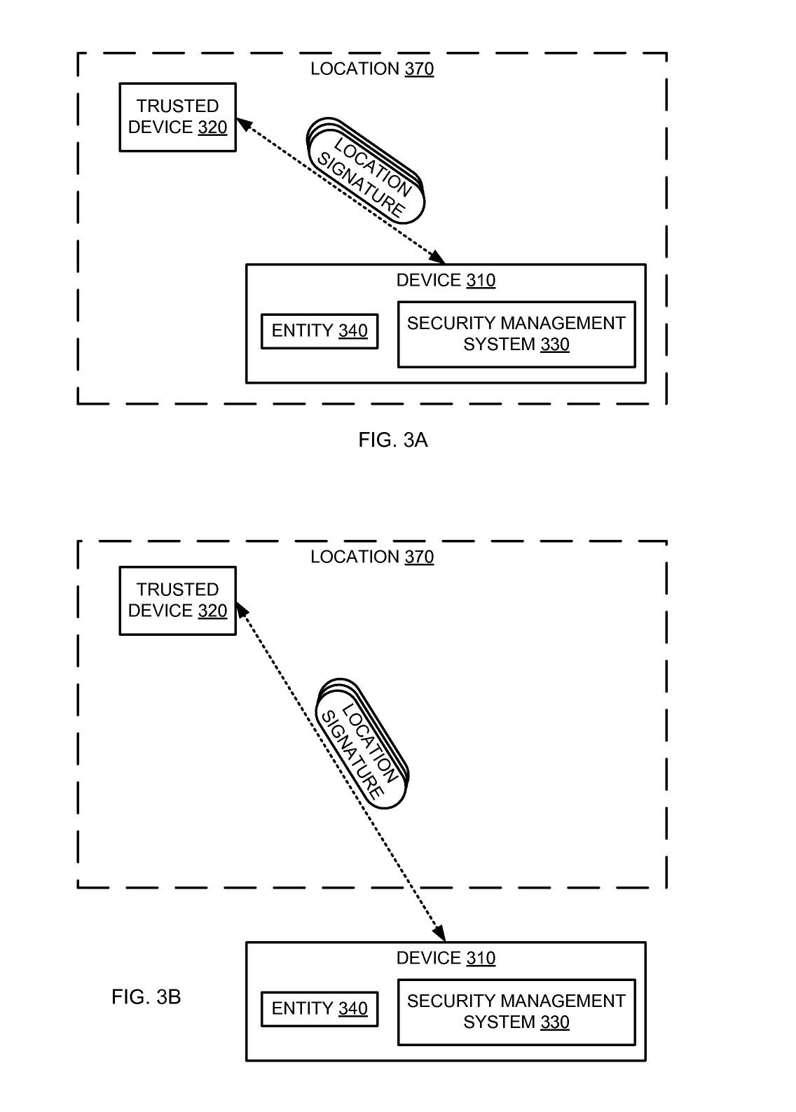

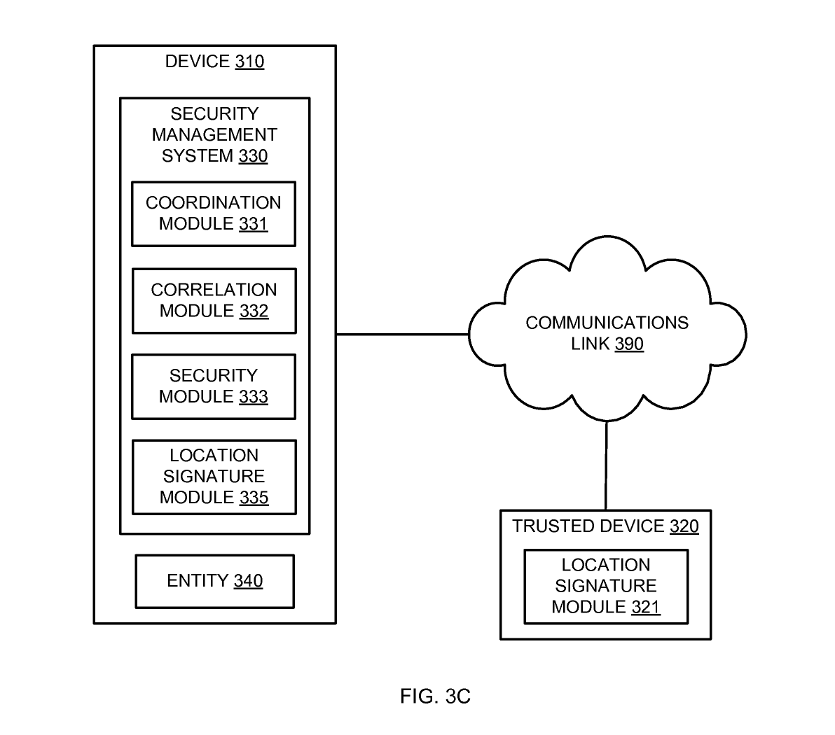

FIGS. 3A, 3B and 3C illustrate an environment including a security management system, according to another implementation. Similar to the example discussed in relation to FIGS. 2A, 2B and 2C, device 310 and trusted device 320 define location signatures and provide these location signatures to a security management system. However, the environment illustrated in FIGS. 3A, 3B and 3C does not include a separate or discrete security management system. Rather, as illustrated in FIGS. 3A, 3B and 3C, security management system 330 is included or hosted at device 310. Additionally, entity 340 is hosted at device 310. For example, entity 340 can be an application, an Internet browser, or a session between an Internet browser and a service or resource.

In other words, in the example illustrated in FIGS. 3A, 3B and 3C, trusted device 320 and device 310 communicate one with another to establish a trusted state of entity 340. Security management system 330 which is hosted at device 310 uses trusted location signatures from trusted device 320 to determine whether a trusted state of entity 340 should be established. When trusted device 320 and device 310 are both within location 370 (as illustrated in FIG. 3A), the candidate location signatures defined at device 310 (i.e., at location signature module 335) are (or are expected to be) correlated with the trusted location signature defined at trusted device 320 (i.e., at location signature module 321), and a trusted state of entity 340 is established. However, if trusted device 320 and device 310 are not both within location 370 (as illustrated in FIG. 3B), the candidate location signatures defined at device 310 not are (or are expected not to be) correlated with the trusted location signature defined at trusted device 320, and a trusted state of entity 340 is revoked (or not established).

As a specific example, trusted device 320 can provide trusted location signatures to security management system 330 at device 310 via, for example, a communications link such as communications link 390 illustrated in FIG. 3C. Security management system 330 includes location signature module 335, which provides candidate location signatures to correlation module 333. For example, coordination module 332 can communicate with trusted device 320 via communications link 390 and with location signature module 335 via an interface internal to device 310 (e.g., a shared memory interface, an application programming interface (API), or some other interface) to coordination definition of location signatures at trusted device 320 (i.e., at location signature module 321 of trusted device 320) and at location signature module 335. Trusted device 320 can then provide trusted location signatures to correlation module 332 via communications link 390 and location signature module 335 can provide candidate location signatures to correlation module 332 via an interface internal to device 310.

Correlation module 332 determines whether candidate location signatures are correlated with trusted location signatures, and communicates with security module 333 to provide signals or indications to security module 333 to indicate whether the candidate location signatures are correlated with the trusted location signatures. If a candidate location signature is correlated with a trusted location signature, security module 333 establishes a trusted state of entity 340. Conversely, as discussed above, if a candidate location signature is not correlated with a trusted location signature, security module 333 revokes (or does not establish) a trusted state of entity 340.

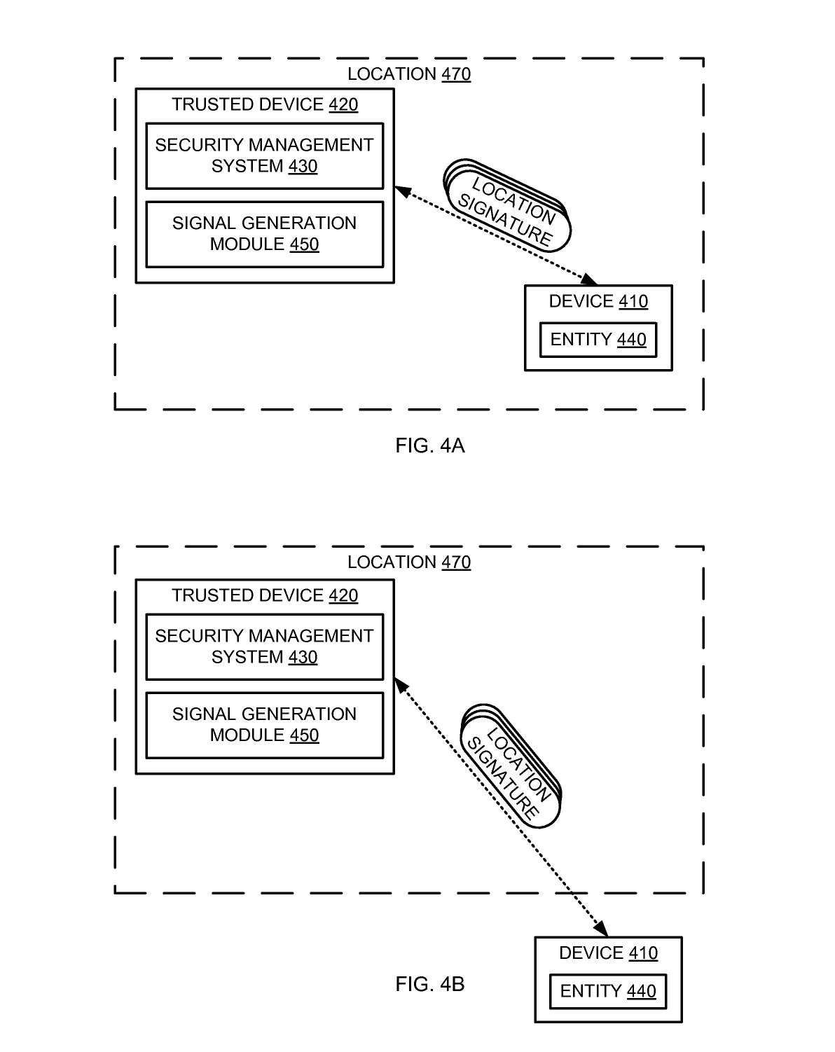

FIGS. 4A and 4B illustrate an environment including a security management system, according to another implementation. The environment illustrated in FIGS. 4A and 4B is similar to those of FIGS. 2A, 2B, 2C, 3A, 3B and 3C, but the security management system is hosted at the trusted device. In other words, device 410 provides candidate location signatures to trusted device 420 (or security management system 430) via, for example, a communications link. Additionally, trusted location signatures can be defined at security management system 430 (or at trusted device 420). In some implementations, security management system 430 can provide synchronizations signals or other information to device 410 and to a location signature module at trusted device 420 to coordinate definition of the location signatures at device 410 and at trusted device 420.

If a candidate location signature is correlated with a trusted location signature (e.g., when trusted device 420 and device 410 are located within location 470 as illustrated in FIG. 4A), security management system 430 can establish a trusted state of entity 440, which is illustrated in this example as hosted at device 410. As a specific example, security management system 430 can provide a token to entity 440 via a communications link. Additionally, if a candidate location signature is not correlated with a trusted location signature (e.g., when trusted device 420 or device 410 is not located within location 470 as illustrated in FIG. 4B), security management system 430 can revoke a trusted state of entity 440 as discussed in other examples herein.

In the example illustrated in FIGS. 4A and 4B, trusted device 420 includes signal generation module 450. A signal generation module is a module that generates a signal or signals such as environment signals that can be detected or sensed at a location signature module. For example, a signal generation module can include a counterweight affixed to a motor to generate vibration signals. As another example, a signal generation module can include an antenna and electronic circuitry to generate electromagnetic signals. In a specific example, a signal generation module can include an antenna and electronic circuitry to implement a near-field communication (NFC) transmitter. Trusted device 420 can also include a processor or controller to emit or generate particular patterns or sequences of signals using signal generation module 450. In some implementations, such patterns or sequences of signals can represent data or information. Thus, a trusted device can generate or emit signals that are detected or sensed at a location signature module within a device.

In such implementations, a location signature module can be absent at a trusted device because the trusted device can include a description or representation of the signals emitted from the signal generation module. That is, the trusted device has a representation of the signals emitted because the trusted device caused those particular signals to be emitted from the signal generation module. Said differently, the representation of the signals can be used or interpreted as a trusted location signature. That description or representation of the signals emitted from the signal generation module can be provided to a security management system, either at the trusted device or at another device or computing system, and compared with a candidate location signature to determine whether the candidate location signature is correlated with that description or representation of the signals emitted from the signal generation module (i.e., a trusted location signature).

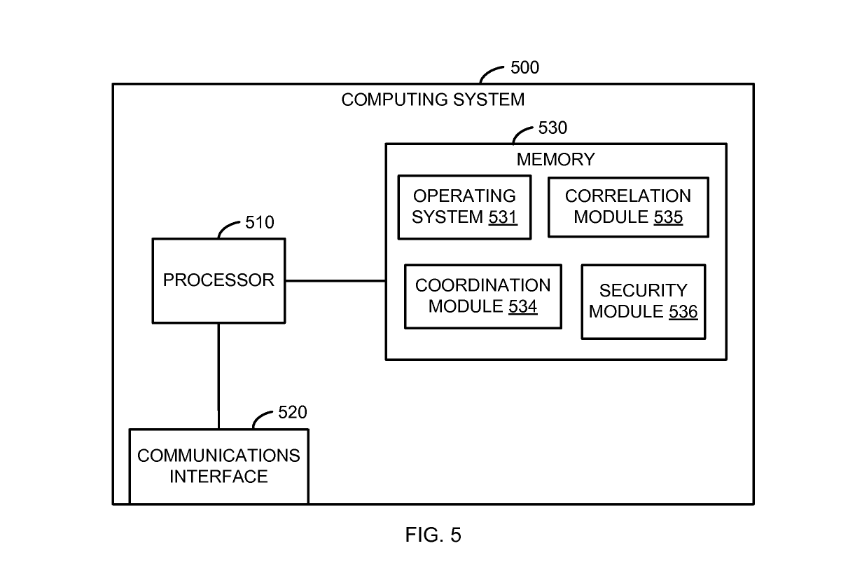

Accordingly, as illustrated in FIGS. 2A, 2B, 2C, 3A, 3B, 3C, 4A and 4B, the methodologies and systems discussed herein can be applied to various environments, topologies, and relationships of devices (e.g., computing systems). FIG. 5 is a schematic block diagram of a computing system hosting a security management system, according to an implementation. In the example illustrated in FIG. 5, computing system 500 includes processor 510, communications interface 520, and memory 530. Computing system 500 can be, for example, a personal computer such as a desktop computer or a notebook computer, a tablet device, a smartphone, or some other computing system. In some implementations, a computing system hosting a security management system is referred to itself as a security management system.

Processor 510 is any combination of hardware and software that executes or interprets instructions, codes, or signals. For example, processor 510 can be a microprocessor, an application-specific integrated circuit (ASIC), a graphics processing unit (GPU) such as a general purpose GPU (GPGPU), a distributed processor such as a cluster or network of processors or computing systems, a multi-core or multi-processor processor, or a virtual or logical processor of a virtual machine.

Communications interface 520 is a module via which processor 510 can communicate with other processors or computing systems via a communications link. As a specific example, communications interface 520 can include a network interface card and a communications protocol stack hosted at processor 510 (e.g., instructions or code stored at memory 530 and executed or interpreted at processor 510 to implement a network protocol) to receive and send data. As specific examples, communications interface 520 can be a wired interface, a wireless interface, an Ethernet interface, an IEEE 802.11 interface, or some other communications interface via which processor 510 can exchange signals or symbols representing data to communicate with other processors or computing systems.

Memory 530 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 530 can be a volatile random access memory (RAM), a persistent data store such as a hard-disk drive or a solid-state drive, a compact disc (CD), a digital versatile disc (DVD), a Secure Digital™ (SD) card, a MultiMediaCard (MMC) card, a CompactFlash™ (CF) card, or a combination thereof or of other memories. In other words, memory 530 can represent multiple processor-readable media. In some implementations, memory 530 can be integrated with processor 510, separate from processor 510, or external to computing system 500.

Memory 530 includes instructions or codes that when executed at processor 510 implement operating system 531 and a security management system including coordination module 534, correlation module 535, and security module 536. In other words, a security management system including coordination module 534, correlation module 535, and security module 536 is hosted at computing system 500.

Computing system 500 can implement methodologies discussed herein. For example, computing system 500 can implement process 100 discussed above in relation to FIG. 1 and/or methodologies discussed in relation to FIGS. 2A, 2B, 2C, 3A, 3B, 3C, 4A, and/or 4B. As a specific example, coordination module 534 can provide synchronization signals via communications interface 520 to a device and a trusted device to coordinate definition of candidate location signature and trusted location signatures, respectively. In other implementations, computing system 500 can host a location signature module (e.g., stored at memory 530 and executed at processor 510) and coordination module 534 can communicate via communications interface 520 with a device or trusted device to coordinate definition of location at signatures at that location signature module and at the device or trusted device.

Correlation module 535 can determine whether candidate location signatures are correlated with trusted location signatures. As a specific example, correlation module 535 can receive location signatures via communications interface 520 and/or from a location signature module hosted at computing device 500 and compare location signatures to determine whether candidate location signatures are correlated with trusted location signatures. Additionally, security module 536 can communicate with security module 536 to provide signals or indications to security module 536 to indicate whether a candidate location signature is correlated with a trusted location signature.

As discussed above, security module 536 can establish a trusted state of an entity (e.g., an entity hosted at computing system 500 or at some other computing system) is a candidate location signature is correlated with a trusted location signature and revoke the trusted state of the entity if a candidate location signature is not correlated with a trusted location signature. For example, security module 536 can provide a credential or token via communications interface 520 to the entity or to a computing device hosting the entity to establish the trusted state of the entity. Additionally, security module 536 can invalidate that credential or token to revoke the trusted state of the entity.

In some implementations, computing system 500 includes or hosts additional modules or components. For example, as discussed above computing system 500 can host an entity and/or a location signature module to define location signatures. In other words, computing system can be a device or a trusted device as discussed, for example, in relation to FIGS. 2A, 2B, and 2C. In other implementations, computing device 500 can be a security management system as discussed, for example, in relation to FIGS. 2A, 2B, and 2C.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor or software that is stored or encoded at a non-transient processor-readable memory), or hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanisms (e.g., sending data to a computing system or agent via a communications path or channel), pull mechanisms (e.g., delivering data to a computing system or agent in response to a request from the computing system or agent), and store mechanisms (e.g., storing data at a data store or service at which a computing system or agent can access the data). Furthermore, as used herein, the term “based on” means “based at least in part on.” Thus, a feature that is described as based on some cause, can be based only on the cause, or based on that cause and on one or more other causes.

What is claimed is:

1. A processor-readable medium including code representing instructions that when executed at a processor cause the processor to:
access a trusted location signature;
access a candidate location signature;
determine that the candidate location signature is correlated with the trusted location signature; and
establish a trusted state of an entity in response to determining that the candidate location signature is correlated with the trusted location signature.

2. The processor-readable medium of claim 1, wherein the trusted location signature is a first trusted location signature, the candidate location signature is a first candidate location signature, and the trusted state of the entity is established at a first time, the processor-readable medium further including code representing instructions that when executed at the processor cause the processor to:
access at a second time after the first time a second trusted location signature;
access at a third time after the first time a second candidate location signature; and
determine whether the second candidate location signature is correlated with the second trusted location signature.

3. The processor-readable medium of claim 1, wherein the trusted location signature is a first trusted location signature, the candidate location signature is a first candidate location signature, and the trusted state of the entity is established at a first time, the processor-readable medium further including code representing instructions that when executed at the processor cause the processor to:
access at a second time after the first time a second trusted location signature;
access at a third time after the first time a second candidate location signature;
determine whether the second candidate location signature is correlated with the second trusted location signature; and
revoke the trusted state of the entity if the second candidate location signature is not correlated with the second trusted location signature.

4. The processor-readable medium of claim 1, wherein the trusted location signature and the candidate location signature each include vibration data.

5. The processor-readable medium of claim 1, further including code representing instructions that when executed at the processor cause the processor to:
receive the trusted location signature via a communications link; and
define the candidate location signature based on values output at an accelerometer.

6. The processor-readable medium of claim 1, further including code representing instructions that when executed at the processor cause the processor to:
receive the trusted location signature via a communications link; and
receive the candidate location signature via the communications link.

7. The processor-readable medium of claim 1, wherein establishing the trusted state of the entity includes providing a credential to the entity.

8. A security management system, comprising:
a coordination module to temporally coordinate definition of trusted location signatures and candidate location signatures;
a correlation module to determine whether a candidate location signature from the candidate location signatures is correlated with a trusted location signature from the trusted location signatures; and
a security module to establish a trusted state of an entity if a first candidate location signature from the candidate location signatures is correlated with a first trusted location signature from the trusted location signatures and to revoke the trusted state of the entity if a second candidate location signature from the candidate location signatures is not correlated with a second trusted location signature from the trusted location signatures.

9. The system of claim 8, further comprising:
a location signature module in communication with the coordination module to define the candidate location signatures.

10. The system of claim 8, further comprising:
a location signature module including an accelerometer in communication with the coordination module to define the candidate location signatures.

11. The system of claim 8, wherein the security module revokes the trusted state of the entity if a candidate location signature is not received before expiration of a timeout period after receiving a previous candidate location signature.

12. The system of claim 8, wherein:
the security module provides a credential to the entity if the first candidate location signature from the candidate location signatures is correlated with the first trusted location signature from the trusted location signatures; and
the security module revokes the credential if the second candidate location signature from the candidate location signatures is not correlated with the second trusted location signature from the trusted location signatures.

13. A security management method, comprising:
receiving trusted location signatures from a first device via a communications link;
receiving candidate location signatures from a second device via the communications link;
establishing a trusted state of an entity if a first candidate location signature from the candidate location signatures is correlated with a first trusted location signature from the trusted location signatures; and
revoking the trusted state of the entity if a second candidate location signature from the candidate location signatures is not correlated with a second trusted location signature from the trusted location signatures.

14. The method of claim 13, further comprising:
coordinating definition of the trusted location signatures at the first device and definition of the candidate location signatures at the second device.

15. The method of claim 13, wherein:
the trusted location signatures are periodically received from the first device; and
the candidate location signatures are periodically received from the second device.

16. The method of claim 13, wherein the establishing the trusted state of the entity includes providing a credential to the entity.
